(19) United States
(12) Patent Application Publication
(10) Pub. No.: US 2013/0301677 A1
(43) Pub. Date: Nov. 14, 2013

(54) TEMPERATURE PROBE FOR TRANSPORT REFRIGERATION

(71) Applicant: THERMO KING CORPORATION, Mineapolis, MN (US)

(72) Inventors: Russell Lee SANDERS, Minnetonka, MN (US); Arthur VOLBRECHT, Genoa City, WI (US); Gayatri ABBOTT, Minneapolis, MN (US)

(73) Assignee: THERMO KING CORPORATION, Mineapolis, MN (US)

(21) Appl. No.: 13/893,673

(22) Filed: May 14, 2013

Related U.S. Application Data
(60) Provisional application No. 61/646,893, filed on May 14, 2012.

(51) Int. Cl. G01K 1/08

(52) U.S. Cl. CPC G01K 1/08
USPC 374/141; 374/209

(57) ABSTRACT

Embodiments of a handheld probe are described. The handheld probe may have a housing. The housing of the handheld probe may have a handle section and a probe shell section that is configured to house a probe. The handle section may have a hexagonal-shaped profile so that the handheld probe can be positioned on a flat surface of the hexagonal-shaped profile. In some embodiments, the handle section may have a center hole that is configured to accept a cable. The cable may be potted in the center hole filled with epoxy to prevent moisture from getting into the cable. In some embodiments, the probe shell section may be configured to have a thin wall so that the handheld probe can have a rapid response to temperature changes. A tip of the probe shell section may also be silver brazed to help with fast temperature response.

### FIELD OF TECHNOLOGY

Embodiments disclosed herein relate generally to a temperature controlled truck, trailer or container. More specifically, the embodiments disclosed herein relate to a temperature probe for use in a temperature controlled truck, trailer or container.

### BACKGROUND

Transport refrigeration systems are used to cool containers, trailers, trucks and other similar transport units. Some goods, such as perishable food, may require to be transported in a temperature controlled container. During the transportation, and/or at the delivery, the temperature of the container or the goods may have to be checked to ensure the quality of the goods has not been affected. A handheld probe may be equipped inside of the container. A user can use the temperature probe to measure the temperature of the container, or the handheld probe may be positioned on the goods (or on the package of the goods) to measure the temperature of the goods.

### SUMMARY

The embodiments disclosed herein relate to a temperature probe for use in a temperature controlled truck, trailer or container.

The temperature probe may be configured to have a probe shell section and a handle section. In some embodiments, an outer surface of the probe shell section and the handle section may be made with a material and configured in such a way to meet food grade sanitary standards such as those set forth by, for example, the National Sanitation Foundation (NSF).

Also, in some embodiments, the outer surface of the probe shell section and the handle section may be constructed to have a contour that minimizes sharp edges, which may help reducing the possibility of damaging the goods.

Further, in some embodiments, a cable that is configured to be connected to a probe housed in the probe shell section may be potted in the handle section with a sealing material. The sealing material may provide structural support for the cable and may prevent moisture from entering the cable.

In some embodiments, the handheld probe may have a probe shell section and a handle section that can withstand sanitary cleaning process, such as a high pressure wash and/or a steam clean process. In some embodiments, an outer surface of the probe shell section and the handle section of the handheld probe may be made of stainless steel.

In some embodiments, the handle section may have a hexagonal-shaped profile so that the handheld probe can be positioned on or taped to a flat surface via a flat side of the hexagonal-shaped profile and/or help tape the probe to a flat surface. In some embodiments, the handle section may have a center hole that is configured to accept a cable. The cable may be potted in the center hole filled with a sealing material such as epoxy to prevent moisture from getting into the handle section. In some embodiments, the probe shell section may be configured to have a thin wall configuration so that the handheld probe can rapidly respond to temperature changes. In some embodiments, the probe shell section may be connected to the handle section by welding or silver brazing.

In some embodiments, a tip of the probe shell section may be silver brazed to help provide a fast temperature response for the handheld probe. In some embodiments, a thermal transfer media, such as grease or epoxy, may be applied to the tip of the probe shell section, so that the tip section can have, for example, a user definable thermal transfer rate. In some embodiments, the probe shell section may be configured to recess in the handle section, and the probe shell section may be welded or silver brazed to the handle section.

### BRIEF DESCRIPTION OF THE DRAWINGS

FIG. 1 illustrates a transport refrigeration system with one embodiment of a handheld probe.

FIGS. 2A to 2C illustrate an embodiment of a handheld probe. FIG. 2A is side view. FIG. 2B is an end view. FIG. 2C is a sectional view from line 2C-2C as shown in FIG. 2B.

FIG. 3 illustrates a portion of an internal space of a transport refrigeration system with an embodiment of a handheld probe.

### DETAILED DESCRIPTION

A transport refrigeration system is used to transport goods that require a temperature controlled environment during transportation, such as temperature controlled container, trailer, or trucks. During the transportation and/or when the goods are delivered, the temperature of the goods and/or the temperature of the container may have to be checked. A handheld probe that is provided inside of the container may facilitate the temperature checking process. A user may be able to put the handheld probe at different locations inside the container to check the temperature of the container. In other applications, the user may position the handheld probe next to the transported goods, or inside a package of the goods to check the temperature of the goods or the package directly. In some embodiments, for example, when the handheld probe is used to check the temperature of a food product directly, the handheld probe may have to meet sanitary standards for food, such as, for example, those required by NSF. In some embodiments, the handheld probe may also have to withstand extreme temperature changes, and/or work in a high moisture environment. In some embodiments, for example when the temperature of the goods needs to be checked at the delivery point, it may be desirable that the handheld probe can provide a quick temperature response to the user. Further, when the container that is equipped with the handheld probe is cleaned, it may be desirable that the handheld probe can withstand the cleaning procedure, such as a high pressure wash or a steam clean process.

In the following description of the illustrated embodiments, embodiments of a handheld probe are described. The handheld probe may have a housing that can withstand a high pressure wash or a steam clean process. In some embodiments, the housing of the handheld probe may be made of stainless steel. The housing of the handheld probe may have a handle section and a probe shell section. The handle section may have a hexagonal-shaped profile so that the handheld probe can be positioned on a flat surface or taped to a flat surface via a flat side of the hexagonal-shaped profile. In some embodiments, the handle section may have a center hole that is configured to accept a cable. The cable may be potted in the center hole filled with epoxy to prevent moisture from getting into the cable. In some embodiments, the probe shell section may be configured to have a thin wall configuration so that the handheld probe can provide a rapid response of temperature changes to the users. In some embodiments, the probe shell section is connected to the handle section by welding or silver brazing. A tip of the probe shell section may also be silver brazed to help ensure a fast temperature response for the handheld probe.

References are made to the accompanying drawings that form a part hereof, and in which is shown by way of illustration of the embodiments in which the embodiments may be practiced. It is to be understood that the terms used herein are for the purpose of describing the figures and embodiments and should not be regarded as limiting the scope of the present application.

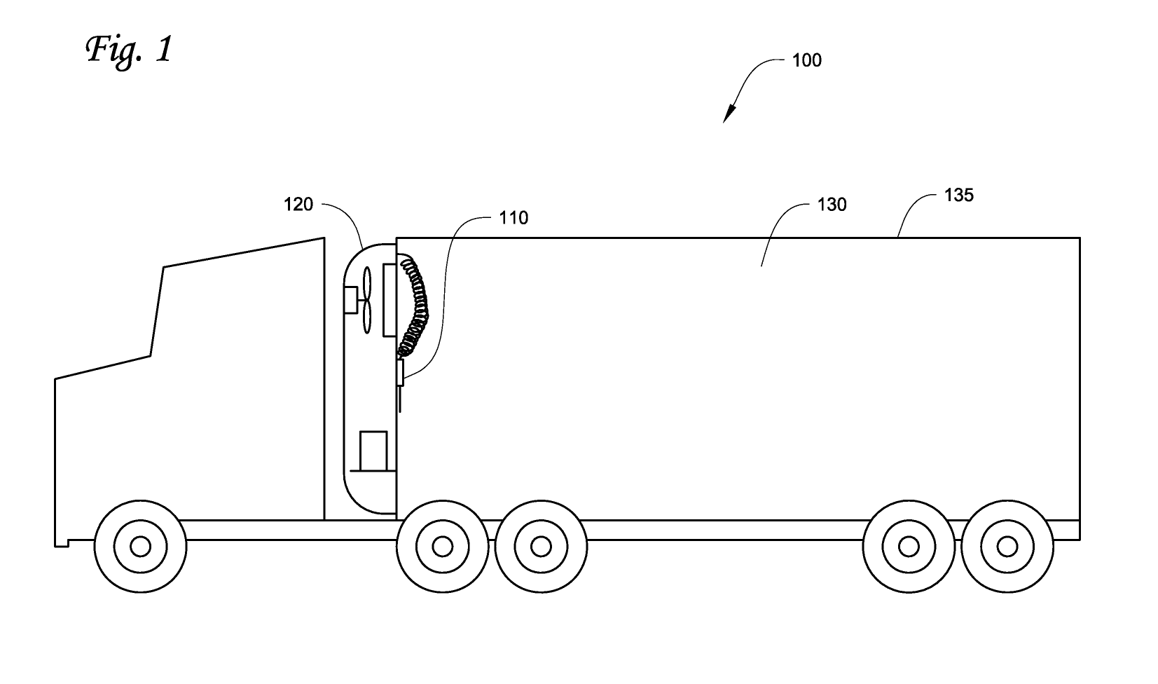

FIG. 1 illustrates a transport refrigeration system 100, with which embodiments of a handheld probe 110 may be used. The transport refrigeration system 100 is a truck with a transport refrigeration unit (TRU) 120 that is configured to regulate a temperature of an internal space 130 of a trailer 135. The TRU 120 is generally positioned outside of a front end of the trailer 135. The handheld probe 110 may be positioned in the internal space 130 of the trailer 135. In the embodiment as illustrated in FIG. 1, the handheld probe 110 may be positioned at a front end of the internal space 130.

It is to be appreciated that the illustration in FIG. 1 is exemplary. The handheld probe 110 may be used for other applications. For example, the handheld probe 110 may be used with a temperature controlled container, railroad package, etc. The handheld prove 110 can also be positioned at different locations within the trailer 135.

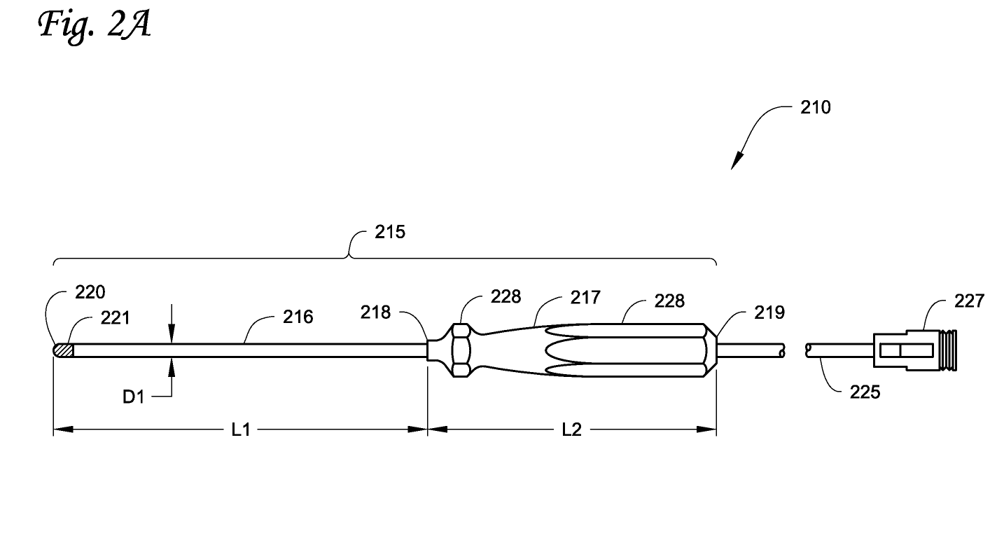

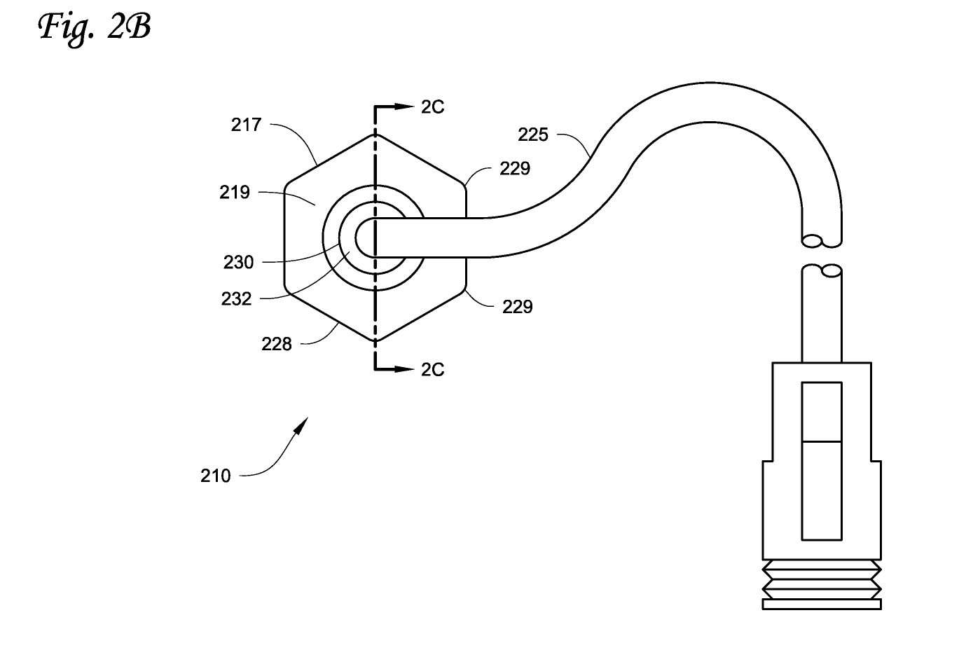

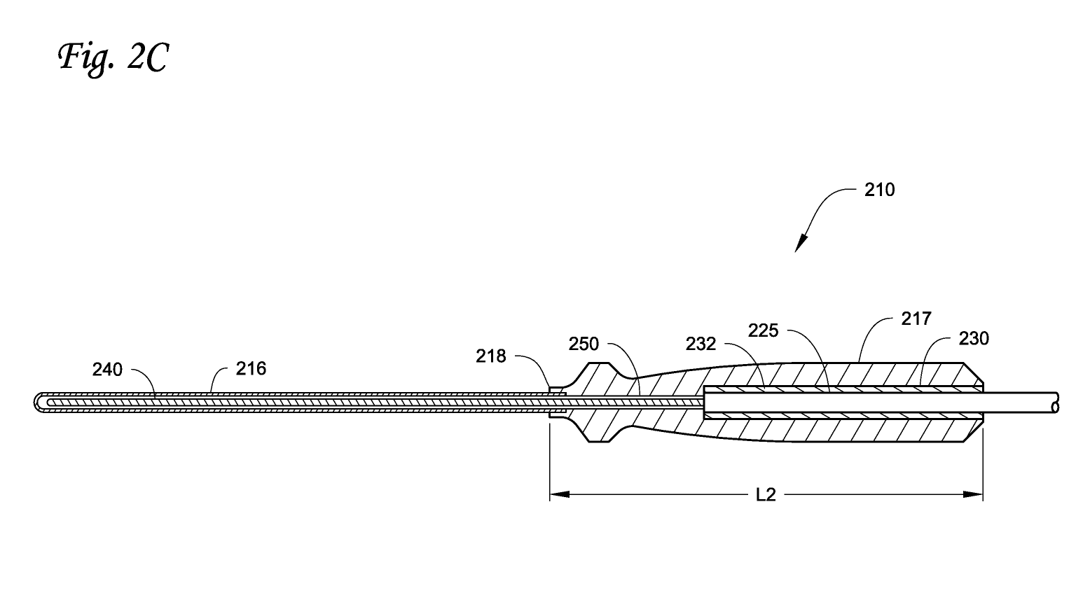

FIGS. 2A to 2C illustrate one embodiment of a handheld probe 210. As illustrated in FIG. 2A, the handheld probe 210 may have a housing 215 that includes a probe shell section 216 and a handle section 217. Both the probe shell section 216 and the handle section 217 may be hollow. The probe shell section 216 is generally configured to house a temperature probe (see the probe 240 in FIG. 2C), and the handle section 217 is generally configure to house a cable (see cable 225 in FIG. 2C).

The probe shell section 216 has a length L1 and the handle section 217 has a length L2. In one embodiment, the length L1 is about 6 inches and the length L2 is about 4.5 inches. The probe shell section 216 may also have a diameter D1. In one embodiment, the diameter D1 is about 0.188 inches.

The handle section 217 has a first end 218 and a second end 219. The first end 218 is configured to receive the probe shell section 216, so that the probe shell section 216 can be attached to the handle section 217. In some embodiments, the probe shell section 216 is attached to the first end 218 of the handle section 217 by welding or silver brazing. The welding or silver brazing may form a seal between the first end 218 and the probe shell section 216.

A tip 220 of the probe shell section 216 is configured to have a rounded shape. The rounded shape may help prevent the tip 220 from penetrating a package of a good during transportation. For example, when transporting food in plastic bags and the handheld probe is attached to the plastic bag to measure a temperature of the packed food, the rounded shaped tip 220 can help prevent the tip 220 from penetrating the plastic bag.

In some embodiments, the probe shell section 216 may be configured to have a thin wall structure. In some embodiments, an end section 221 (shaded area that can include the tip 220) of the probe shell section 216 may be silver brazed. The thin wall structure and the silver brazing may help increase heat transfer efficiency of the probe shell section 216, so that a temperature probe (see the probe 240 in FIG. 2C) housed in the probe shell section 216 may respond relatively quickly to a temperature change. In one embodiment, the temperature probe housed in the probe shell section 216 may be configured to reach equilibrium in about 25 seconds when the handheld probe 210 is put into a water bath of about 50 degrees Celsius from room temperature. In one embodiment, the temperature probe housed in the probe shell section 216 may reach equilibrium in about 25 seconds when the environment temperature changes about 60%. In some embodiments, the response time of the temperature probe 240 may match the response time of other sensors, such as a temperature sensor of the refrigeration unit (such as the refrigeration unit 120 in FIG. 1).

In some embodiments, other thermal transfer media, such as grease or epoxy, can be applied to the end section 221 so that the end section 221 can have a user definable heat transfer rate.

The second end 219 is configured to receive a cable 225. The cable 225 exits the handle section 217 from a hole (see hole 230 in FIG. 2B) of the second 219. The cable 225 is terminated at a connector 227. The connector 227 is configured to be connected to another cable that has a corresponding connector (not shown) that can be matched to the connector 227. The cable 225 may be configured to enclose wires (not shown) that are connected to the temperature probe that is housed in the probe shell section. The cable 225 is configured to protect the enclosed wires. The connector 227 has contacts that are coupled to the wires so that temperature dependent characteristics of the temperature probe may be measured from the contacts in the connector 227. The cable 225 may be made from a material that is resistant to moisture, for example PVC.

The handheld probe 210 may be configured to withstand sanitary procedures, such as for example a 2000 psi high pressure wash or a steam clean process. In some embodiments, the housing 215 may be made of a material that meets the sanitary standards for food products, such as those standards set forth by NFS. The handheld probe 210 may also be may be made of a material that can help withstand corrosion. In some embodiments, the housing 215 may be made of stainless steel. The handle section 217 may be milled from a single stainless steel rod. By milling the handle section 217 to its final shape, gaps on the surface of the housing 215 may be minimized, which may help prevent the microorganisms such as bacteria from accumulating on the surface of the housing 215. In some embodiments, the surface of the housing 215 may be polished so that the surface of the housing 215 can be easily cleaned. In some embodiments, the surface of the housing 215, particularly the handle section 217 of the housing 215, may be configured to have a surface contour that minimize sharp edges, which may help, for example, prevent the handheld probe 210 from damaging the goods.

In the embodiment as shown in FIG. 2A, the handle section 217 may also have a hexagonal profile 228 along at least a portion of the length L2. The hexagonal profile 228 may allow the handheld probe 210 to rest on a flat surface. It is to be appreciated that the hexagonal profile 228 is exemplary; the handheld probe 210 can have other configurations. For example, in other embodiments, the handheld probe may have a rounded shape, a rectangular shape, a square shape, a triangular shape, etc. The profile 228 of the handle section can be constructed to have rounded edges 229.

FIG. 2B illustrates an end view of the handheld probe 210 from the second end 219. As discussed above, the handheld probe 210 has a hexagonal profile 228, which creates a flat side for the handheld probe 210 to rest on. In some applications, the flat side of the hexagonal profile 228 can help the handheld probe 210 be attached to a surface with a tape.

Also illustrated in FIG. 2B, the handle section 217 has a hole 230 that is configured to receive the cable 225. The cable 225 extends out of the hole 230 from within the handle section 217. The cable 225 is potted in the hole 230 by a sealing material 232, such as, for example, epoxy. The sealing material 232 helps seal a space between the hole 230 and the cable 225 so that moisture can be prevented from entering the hole 230. The sealing material 232 may also help support the cable 225.

In FIG. 2C, a cross section of the handheld probe 210 from line 2C-2C as shown in FIG. 2B is illustrated. As illustrated and as discussed above, the probe shell section 216 and the handle section 217 are hollow structures. The probe shell section 216 may be configured to receive a probe 240, such as, for example, a temperature probe. Various types of temperature sensor can be used, such as a thermistor or an integrated circuit temperature sensor. The probe 240 is connected to the cable 225 that is housed in the hole 230 of the handle section 217. The hole 230 extends into the handle section 217. In some embodiments, the hole 230 extend to about ⅔ of the length L2 of the handle section 217. The cable 225 is potted in the hole 230 by the sealing material 232.

The hole 230 is in communication with a connecting hole 250 that is disposed between the hole 230 and the probe shell section 216. The connecting hole 250 generally has a smaller diameter than the hole 230. The cable 225 generally does not enter the connecting hole 250. The connecting hole 250 is configured to guide the probe 240 to go through the connecting hole 225 of the handle 217 to the probe shell section 216.

As illustrated in FIG. 2C, a portion of the probe shell section 216 can recess into the handle 217 at the first end 218. The recessed portion of the probe shell section 216 and the first end 218 can be welded or silver brazed. Since the hole 230 is also sealed by the sealing material 232, the hollow internal space of the handle section 217 and the probe shell section 216 is sealed. This may help the handheld probe 210 withstand sanitary procedures, such as procedures set forth by NSF including a high pressure wash or a steam clean process.

The handheld probe 210 may be configured to enclose a temperature probe, so that the handheld probe 210 can be configured to measure temperature. In some other embodiments, the handheld probe 210 may be configured to enclose other probes so that other parameters may be measured.

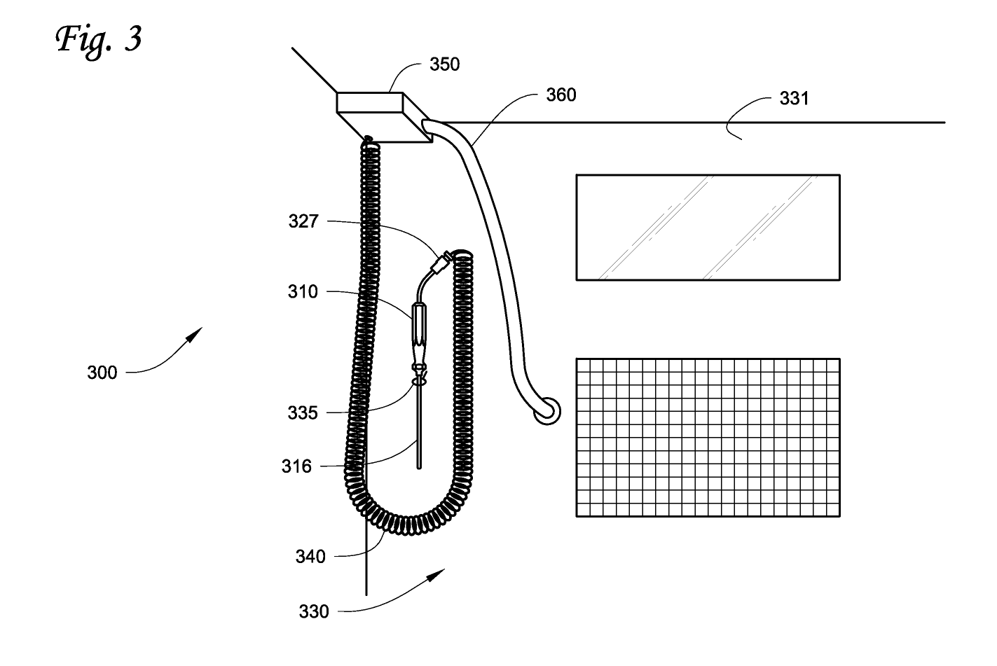

FIG. 3 illustrates a portion of an internal space 330 of a transport refrigeration system 300 that includes a handheld probe 310.

The handheld probe 310 may be removably attached to a front wall 331 of the internal space 330 by, for example, a hook 335. The hook 335 may have a hole to receive a probe shell section 316 of the handheld probe 310.

A connector 327 of the handheld probe 310 may be configured to connect to a corresponding connector of a coiled cable 340 of the internal space. In some embodiments, the connector 327 and the connector of the coiled cable 340 may be compatible Deutsch connectors. In one embodiment, the coiled cable 340 may be about 8 to 10 feet in length. The coils of the coiled cable 340 are elastic so that a reach of the handheld probe 310 that is attached to the coiled cable 340 can be extended; and the coiled cable 340 can return to its original configuration when the handheld probe 310 is repositioned in the hook 335.

In other embodiments, a handheld probe can be configured to be connected to a cable wheel. (Not shown.) The cable is reeled on the cable wheel. When in use, pulling the handheld probe can cause the cable reeled on the cable wheel to be pulled out, so that the reach of the handheld probe can be extended. The cable wheel can be configured to retract the cable when the handheld probe is repositioned to a hook.

The connection between the handheld probe 310 and the coiled cable 340 (or a cable reeled on a cable wheel as discussed above) may be configured to be detachable. This may help prevent the coiled cable 340 from breaking if the handheld probe 310 is attached to a product (not shown), and the produce can be removed from the internal space 330 accidently without detaching the handheld probe 310 from the product. On the other hand, the connection between the handheld probe 310 and the coiled cable 340 (or cable reeled on the cable wheel as discussed above) may be configured to be strong enough to withstand a pullout force to pull the coils of the coiled cable 340 (or to pull the cable out of the cable wheel). In some embodiments, a pull out force of the connection made by the connector 327 to the coiled cable 340 (or cable reeled on the wheel as discussed above) may be about 30 lbs to 70 lbs. It is noted that the handheld probe 310 can be connected to the coiled cable 340 directly without the connector 327.

The handheld probe 310 is coupled to a junction package 350 through the coiled cable 340. The junction package 350 is configured to couple the coiled cable 340 to a controller (not show) of the transport refrigeration system though the cable 360, so that the measurements of the handheld probe 310 can be obtained by the controller.

In use, a user may remove the handheld probe 310 from the hook 335 and place the handheld probe 310 at a place within the internal space 330 to do measurement. For example, when packages of goods are being transported, the handheld probe 310 may be attached to the package, for example by a tape. In another embodiment, at a delivery point, the handheld probe 310 may be positioned directly on the goods, so that, for example, a temperature of the goods can be measured directly.

When the goods are delivered, the handheld probe 310 may be positioned back to the hook 335. If necessary, the internal space 330 may be cleaned by, for example, a high pressure wash or other suitable method. The handheld probe 310 can withstand the high pressure wash and may be cleaned by the high pressure wash together with the internal space 330.

### Aspects

It is noted that any of the aspects 1-8 below can be combined with any of aspects 9-16 and aspect 17. Any of aspects 9-16 can be combined with aspect 17.

1. A handheld probe for a transport refrigeration system, comprising:
a housing including a probe shell section and a handle section, the probe shell section attached to the handle section;
a probe housed in the probe shell section;
a cable coupled to the probe, the cable potted in the handle section by a sealing material;
wherein the probe shell section is configured to enclose the probe, an end of the probe shell section is silver brazed, and the handle section is configured to be one piece.

2. The handheld probe of aspect 1, wherein the housing is made of stainless steel.

3. The handheld probe of aspects 1-2, wherein the handle section has a hexagonal-shaped profile.

4. The handheld probe of aspects 1-3, wherein the handle section includes a flat side for mounting the handheld probe to a flat surface of the transport refrigeration system.

5. The handheld probe of aspects 1-4, wherein the probe shell section has a rounded tip.

6. The handheld probe of aspect 3, wherein the hexagonal-shaped profile of the handle section has rounded edges.

7. The handheld probe of aspects 1-6, wherein the probe is sealed in the housing so as to withstand a pressure wash or a steam clean process.

8. The handheld probe of aspects 1-7, wherein the probe shell section is welded or silver brazed to the handle section so as to seal the probe in the probe shell section.

9. A transport refrigeration system, comprising:
a transport refrigeration unit configured to cool an internal space of the transport refrigeration system;
a handheld probe positioned in the internal space of the transport refrigeration system;
the handheld probe including a probe shell section and a handle section, the probe shell section attached to the handle section;
a probe housed in the probe shell section;
a cable coupled to the probe, the cable potted in the handle section by a sealing material;
wherein the probe shell section is configured to enclose the probe, an end of the probe shell section is silver brazed, and the handle section is configured to be one piece.

10. The transport refrigeration system of aspect 9, wherein the handheld probe is connected to the transport refrigeration unit through a Deutsch connector.

11. The transport refrigeration system of aspects 9-10, wherein the handheld probe is connected to the transport refrigeration unit through a detachable connector.

12. The transport refrigeration system of aspects 9-11, where in the handheld probe is connected to a connector through an elastic coiled cable.

13. The transport refrigerant system of aspects 9-12, wherein the handheld probe is removably attached to a surface of the internal space through a hook.

14. The transport refrigeration system of aspects 9-13, wherein the probe is sealed in the handheld probe so as to withstand a pressure wash or a steam clean process.

15. The transport refrigerant system of aspects 9-14, wherein the handheld probe is configured to measure a temperature of the internal space.

16. The transport refrigerant system of aspect 15, wherein the handheld probe has a response time that matches a temperature sensor of the transport refrigeration unit.

17. A handheld probe for a transport refrigeration system, comprising:
a housing including a probe shell section and a handle section, a first end of the probe shell section extending into a first end of the handle section, and the first end of the probe shell section welded or silver brazed to the first end of the handle section;
a probe housed in a the probe shell section and the probe positioned on a second end of the probe shell, and the second end of the probe shell section silver brazed;
the probe extended into the first end of the handle section;
a cable coupled to the probe extended into the first end of the handle section, the cable extending toward a second end of the handle section, and the cable sealed in the handle section;
wherein the handle section has a hexagonal-shaped profile that includes a flat side for mounting the handheld probe to a flat surface of the transport refrigeration system, the probe shell section has a rounded tip, and the hexagonal-shaped profile of the handle section has rounded edges.

With regard to the foregoing description, it is to be understood that changes may be made in detail, especially in matters of the construction materials employed and the shape, size and arrangement of the parts without departing from the scope of the present invention. It is intended that the specification and depicted embodiment to be considered exemplary only, with a true scope and spirit of the invention being indicated by the broad meaning of the claims.

We claim:

1. A handheld probe for a transport refrigeration system, comprising:
a housing including a probe shell section and a handle section, the probe shell section attached to the handle section;
a probe housed in the probe shell section;
a cable coupled to the probe, the cable potted in the handle section by a sealing material;
wherein the probe shell section is configured to enclose the probe, an end of the probe shell section is silver brazed, and the handle section is configured to be one piece.

2. The handheld probe of claim 1, wherein the housing is made of stainless steel.

3. The handheld probe of claim 1, wherein the handle section has a hexagonal-shaped profile.

4. The handheld probe of claim 1, wherein the handle section includes a flat side for mounting the handheld probe to a flat surface of the transport refrigeration system.

5. The handheld probe of claim 1, wherein the probe shell section has a rounded tip.

6. The handheld probe of claim 3, wherein the hexagonal-shaped profile of the handle section has rounded edges.

7. The handheld probe of claim 1, wherein the probe is sealed in the housing so as to withstand a pressure wash or a steam clean process.

8. The handheld probe of claim 1, wherein the probe shell section is welded or silver brazed to the handle section so as to seal the probe in the probe shell section.

9. A transport refrigeration system, comprising:
a transport refrigeration unit configured to cool an internal space of the transport refrigeration system;
a handheld probe positioned in the internal space of the transport refrigeration system;
the handheld probe including a probe shell section and a handle section, the probe shell section attached to the handle section;
a probe housed in the probe shell section;
a cable coupled to the probe, the cable potted in the handle section by a sealing material;
wherein the probe shell section is configured to enclose the probe, an end of the probe shell section is silver brazed, and the handle section is configured to be one piece.

10. The transport refrigeration system of claim 9, wherein the handheld probe is connected to the transport refrigeration unit through a Deutsch connector.

11. The transport refrigeration system of claim 9, wherein the handheld probe is connected to the transport refrigeration unit through a detachable connector.

12. The transport refrigeration system of claim 9, where in the handheld probe is connected to a connector through an elastic coiled cable.

13. The transport refrigeration system of claim 9, wherein the handheld probe is removably attached to a surface of the internal space through a hook.

14. The transport refrigeration system of claim 9, wherein the probe is sealed in the handheld probe so as to withstand a pressure wash or a steam clean process.

15. The transport refrigeration system of claim 9, wherein the handheld probe is configured to measure a temperature of the internal space.

16. The transport refrigeration system of claim 15, wherein the handheld probe has a response time that matches a temperature sensor of the transport refrigeration unit.

17. A handheld probe for a transport refrigeration system, comprising:
a housing including a probe shell section and a handle section, a first end of the probe shell section extending into a first end of the handle section, and the first end of the probe shell section welded or silver brazed to the first end of the handle section;
a probe housed in a the probe shell section and the probe positioned on a second end of the probe shell, and the second end of the probe shell section silver brazed;
the probe extended into the first end of the handle section;
a cable coupled to the probe extended into the first end of the handle section inside the handle section, the cable extending toward a second end of the handle section, and the cable sealed in the handle section;
wherein the handle section has a hexagonal-shaped profile that includes a flat side for mounting the handheld probe to a flat surface of the transport refrigeration system, the probe shell section has a rounded tip, and the hexagonal-shaped profile of the handle section has rounded edges.
